(19) United States
(12) Patent Application Publication
(10) Pub. No.: US 2006/0069552 A1
(43) Pub. Date: Mar. 30, 2006

(54) Apparatus and method for displaying signals of a detector

(76) Inventor: Mark T. Spitler, Boyds, MD (US)

Correspondence Address: Brian L. Michaelis, Esq.;Brown Rudnick Berlack Israels LLP, One Financial Center, Boston, MA, 02111, US

(21) Appl. No.: 11/207,654

(22) Filed: Aug. 19, 2005

Related U.S. Application Data
(60) Provisional application No. 60/603,097, filed on Aug. 20, 2004.

(51) Int. Cl. G10L 19/10

(52) U.S. Cl. 704/219

(57) ABSTRACT

An analytical element is disclosed for indicating concentration of a target analyte. The analytic element includes a transparent layer having a first side and a second side. A reactive layer faces the first side of the transparent layer. This reactive layer changes colorimetrically in response to concentration of the target analyte. A visually engineered layer is applied to the second side of the transparent layer so to form a display. A substantially linearly-varying signal displayed on the display is perceived by a user as a step-like signal.

### CROSS-REFERENCE TO RELATED APPLICATIONS

This application claims the benefit of U.S. Provisional Application No. 60/603,097, filed in the U.S. Patent and Trademark Office on Aug. 20, 2004, the entire contents of this disclosure being hereby incorporated by reference herein.

### TECHNICAL FIELD

The present disclosure relates generally to displays for signaling a response of a detector, and more particularly, to analytical elements having a viewing surface that changes in color, fluorescence, luminance, etc. in response to the presence of one or more chemical or biological analytes.

### BACKGROUND OF THE INVENTION

Test strips and similar analytical elements, for example, single-use test papers, chemical warning badges, dipsticks and test kits, for detection of chemical or biological substances are used in large part to obtain information quickly. Most types of test strips provide the analytical signal as a color change that develops in a monotonically increasing fashion in response to the presence or concentration of the target analyte. Readout is accomplished through comparison with a reference color chart from which a result is obtained that is generally a numerical value. The process of matching the exposed and fully developed analytical element to the reference color chart can be slow and subjective, and its accuracy is highly dependent on the observer and ambient lighting conditions.

### SUMMARY OF THE INVENTION

The present invention provides a detector effective for minimizing ambiguity and maximizing user reaction by creating the appearance of a binary (for example, “YES/NO”, “OK/NO”, etc.) response from the continuous readout of a typical colorimetric analytical element such as a warning badge or test strip.

In solving the problems associated with the prior art, Applicant has recognized that human perception is affected by the structural features and visual context or surroundings of an image, as in optical illusions. The present invention uses such visual perceptions to modify human perception of a colored signal so as to change a continuously varying visual property into a binary perception. An example of such a continuously varying visual property is a continuous hue shift (e.g. blue to green to yellow). Another example is a continuous luminance shift (e.g. white to pale blue to dark blue). A binary perception is one that is intended to trigger or not trigger an unambiguous human response such as a warning or call to action. This can be accomplished if an approximately linear or at least smoothly monotonic signal display (for example, a test strip responding to varying levels of a chemical by a corresponding deepening of color) can be made to be perceived as a more non-linear (or ideally discontinuous) visible signal.

The present invention includes a display composed of selected image elements so as to convert a detector characteristic curve that is a property of a particular signal into a non-linear perceptual signal for its display. Psychological, psychophysical and physical means are used to generate these non-linear perceptual signals. Readout schemes for calorimetric analytical elements (such as test strips or chemical exposure badges) provide the perception of a sharp or sudden change in the signal from a smoothly varying calorimetric detector signal. Converting smoothly varying calorimetric analytical signals into distinctly appearing symbolic readouts is achieved without modification of the underlying analytical chemistry. Instead, patterns can be conventionally printed above or below a layer of active analytical chemistry in which the calorimetric signal is incorporated into the resultant viewable display.

In one particular embodiment, the present invention uses image elements to modify the human perception of the display of a detector response. The image elements take advantage of both the physical characteristics of the human eye and the psychophysical and psychological phenomena associated with the image-processing mechanisms inherent in the human brain. Appropriately chosen combinations of these phenomena can affect the human perception of a colorimetric signal in a non-linear fashion so as to create a sudden, “step-like” perception of a symbolic signal from a linearly or smoothly varying color change. Judicious selection of image elements can result in a more threshold-like perception of the signal onset than that possible with an unmodified detector signal.

The detector according to the present invention has a fast and unambiguous readout capability of immense utility, for example to first responders encountering emergency exposure to hazardous materials and needing to know whether safe exposure limits have been exceeded. The finite rate and continuous nature of the color change typical of many analytical elements can create a sense of ambiguity and confusion as to whether and when an actionable threshold as been exceeded.

### BRIEF DESCRIPTION OF THE DRAWINGS

The foregoing features and advantages of the present invention will be understood by reference to the following description, taken in connection with the accompanying drawings, in which:

FIG. 1A is a perspective view of an analytical element according to an illustrative embodiment of the present invention;

FIGS. 1B and 1C are plan views of the analytic element shown in FIG. 1A;

FIG. 2 shows in the form of a dose-response curve the effect of converting a linear change in color intensity or hue into an ideal step response and how the completeness of this conversion can be measured;

FIG. 3 shows how a linearly increasing colorimetric signal can conceptually be converted into a ranked series of responses if symbols can be made to appear in a more or less sudden fashion at critical levels of color intensity;

FIG. 4 shows an example of a calorimetric multilayer integral analytical element incorporating a visually engineered layer through which the calorimetric change is perceived;

FIG. 5 illustrates that, as a result of the structure of the rods and cones in the human retina, at a fixed distance the eye is more sensitive to certain line spacings than others, i.e. certain spatial frequencies;

FIG. 6 illustrates how a Visually Engineered Image can be assembled from subimages, some of which incorporate the calorimetric signal, which the human visual system will assemble into a symbolic readout;

FIG. 7 shows the sensitivity of the human eye to contrast as a function of the spatial frequency of parallel lines;

FIG. 8 shows a simple example of using a mask over a colorimetric signal to create a symbolic readout, in this case an “X”;

FIG. 9 is a representation of a Reactive Layer, a layer of material that gradually changes color, e.g. from off-white to dark blue, depending on the presence or concentration of an analyte;

FIG. 10 illustrates a Reference Ring;

FIGS. 11A and 11B illustrates an Opaque Layer, and its effect on an underlying Reactive Layer;

FIG. 12 shows the effect of a Semi-transparent Layer;

FIGS. 13A, 13B and 13C shows different ways of implementing a Semi-transparent Layer;

FIG. 14 shows a Semi-transparent layer in a color complementary to that produced by the Reactive layer;

FIG. 15 shows the effect of spatial frequency on a halftone pattern; and

FIG. 16 illustrates the effect of adding distracting elements to a Semi-transparent Layer.

### DETAILED DESCRIPTION

As used in the present disclosure, the term display refers to any reflective, emissive, transparent or other means of generating an image. Image elements are any single or group of pixels, used to make an image. A detector is a means of causing a change in a display (for example, a chemical reaction that causes a change of color, a liquid crystal responsive to temperature or pressure, etc.). A signal is a response to physical changes in the environment (for example, temperature, the presence of or reaction with a chemical compound, etc.) that causes changes in the detector. A detector characteristic signal is a system response as measured by some physical means (for example, a change in color of a display in response to a chemical or physical reaction). A non-linear perceptual signal is any altered display that changes the appearance of the detector characteristic signal so as to make it appear less and/or more visible. An active image element is one that incorporates the signal.

The means to generate non-linear perceptual signals can be classified into three categories: Psychological, Psychophysical, and Physical. Psychological means employ patterns of image elements to create figure and grounds that alter the perception of the detector characteristic signal. Some changes will make the detector characteristic signal less visible, while other will make it more visible.

Psychophysical means utilize the characteristics of the brain's image processing methods. An example is to employ patterns of image elements to segment the detector characteristic signal into specific human spectral channels to control its visibility. Another example of a psychophysical means is to employ patterns of image elements to segment the detector characteristic signal into specific human spatial frequency channels to control its visibility.

Physical means employ patterns of image elements to segment the detector characteristic signal in order to control the amount of light sent to the observer relative to other areas. These techniques include the use of opaque and transparent image segments, semi-transparent and transparent image segments, halftone (visible and invisible) and uniform image segments, and color mixture and color matching image segments.

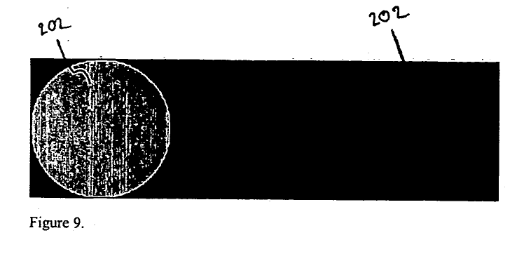

One form of display is a reactive layer, a layer of detector material that changes color in response to a chemical or physical perturbation. FIG. 9 is a representation of a reactive layer 202, a layer of material that gradually changes color, for example, from off-white to dark blue, depending on the presence or concentration of an analyte. An example of a reactive layer would be a colorimetric analytical element, such as a chemical test strip. The display is combined with additional image elements to form the display as modified according to the present invention. The additional image elements constitute a Visually Engineered Image.

These additional image elements can take many forms and be implemented in many ways, as demonstrated in the following examples. They may be taken individually or in combination. They may be made in any appropriate fashion, such as conventional four-color printing, silk screening, painting, or masking or removing parts of the reactive layer. They are most conveniently made by any of various printing techniques, whereby they are printed onto the surface of the display.

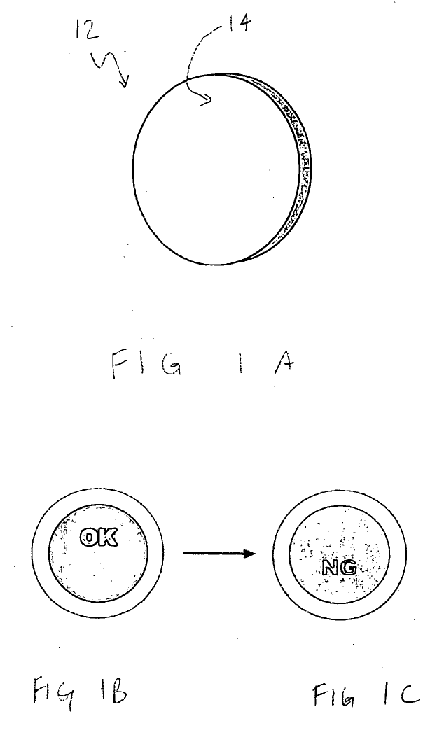

FIG. 1A is a perspective view of an analytic element 12, according to the principles of the present invention. Analytic element 12 has a viewing surface or display 14 that displays a signal. The signal can be, for example, changes in color or related visual phenomena (e.g., hue, fluorescence, luminance, saturation, etc.) in response to the presence of one or more target analytes. In the illustrative embodiment, analytic element 12 takes the form of a warning badge. However, analytic element 12 can also be a test strip, single-use test paper, dip stick or test kit for detection of chemical or biological substances. In the present embodiment, the analytical element 12 displays an analytical signal in response to the presence or concentration of a target analyte.

FIGS. 1B and 1C are plan views of the analytic element 12 in its unexposed and exposed states, respectively, and illustrate how the analytical element 12 changes upon exposure to an analyte. Advantageously, the symbolic readout appears suddenly and distinctly once a threshold level of analyte is exceeded. Such a fast and unambiguous readout capability is of immense utility, for example to first responders encountering emergency exposure to hazardous materials and needing to know whether safe exposure limits have been exceeded. The present invention minimizes ambiguity and maximizes user reaction by creating the appearance of a binary (for example, YES/NO, OK/NG, etc.) readout. That is, a substantially linear (i.e., smoothly monotonic) signal to be perceived as a substantially non-linear (i.e., discontinuous) signal.

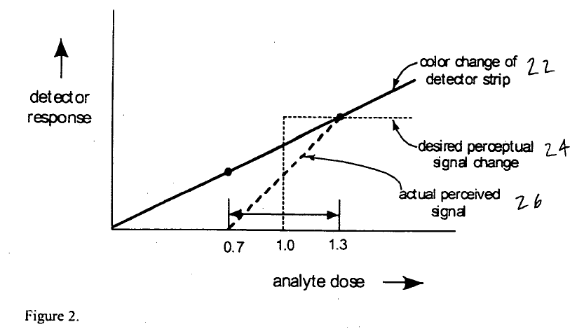

FIG. 2 illustrates, in the form of a dose-response curve 22, the effect of converting a linear change in color intensity or hue into an ideal step response, and how the completeness of this conversion can be measured. The present invention provides for sharpening the perceived transition between the detector “off”, unexposed, or unreacted state of analytic element 12, and the detector “on”, exposed, or reacted state of element 12. The unmodified response of the analytical element 12 is a smoothly rising curve 22, often linear as shown by the solid line in FIG. 2.

The desired or ideal perception of the detector response is as a threshold, shown as the step function 24 in FIG. 2. However, attainment of a perfect step function is often impossible and generally unnecessary. What is needed to enhance the human perception of the detector response is for the perceived signal to be effectively zero below a certain threshold dose level, for example, 0.7, followed by a steeply rising perceived signal over a small dose increase, for example 0.7 to 1.3, as shown by the dotted line 26 in FIG. 2. The present invention provides a way to significantly reduce the human perception of the first part of the inherent detector response curve 22 (i.e., below the threshold), and then to maximize the perceived signal change over as small and incremental an analyte dose as possible.

The present invention transforms the continuous, monotonic response 22 of the analytic element 12 into a stepped, threshold signal 24 by exploiting idiosyncratic features of the human eye as a visual sensor. These well-known features result in extreme sensitivities of the eye to specific combinations of color, luminance, contrast, and spatial frequency. An important advantage of the present invention is the application of combinations of these features to usefully transform the human perception of a calorimetric signal. The perception of a stepped, threshold signal 24 is very valuable to users in situations requiring an unambiguous signal and a rapid user response. The present invention allows a user to perceive changes in the signal of analytic element 12 with clarity and certainty, without resource to comparators or instruments.

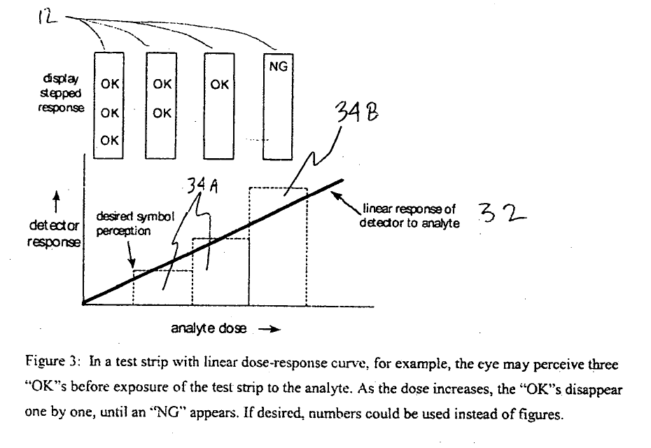

FIG. 3 illustrates how a linearly increasing colorimetric signal can conceptually be converted into a ranked series of responses if symbols can be made to appear in a substantially sudden or instantaneous fashion at critical levels of color intensity. In a test strip 12 with a linear dose-response curve 32, the eye may perceive three “OK”s before exposure of the test strip 12 to the analyte. As the dose increases, the “OK”s disappear one by one, until an “NG” appears. Alternatively, numerals or other symbols could be used instead of text. Each step 34A up to the last results in the disappearance of the word “OK”. The last step 34B then changes the “OK” to an “NG”.

The difficulties inherent in designing a system to alter signal perception are several. For example, the symbols must be clearly perceived when they should be seen, and imperceptible when they should not be seen. Typically, the step function change 24 in symbol appearance is not exactly vertical as depicted in FIG. 2. The present invention, however, is able to minimize the change in dose required to induce this step function change in perception.

According to the present invention, these perceptual changes can be achieved by modifying the viewing surface of a colorimetric analytical element 12 with patterns, designs or impressions that alter the perception of the color development of analytical element 12. This surface modification to engineer the viewer's perception of the signal, referred to herein as “Visual Engineering”, transforms (to the eye) the continuous response of the analytical element 12 into a step function development of symbols or figures.

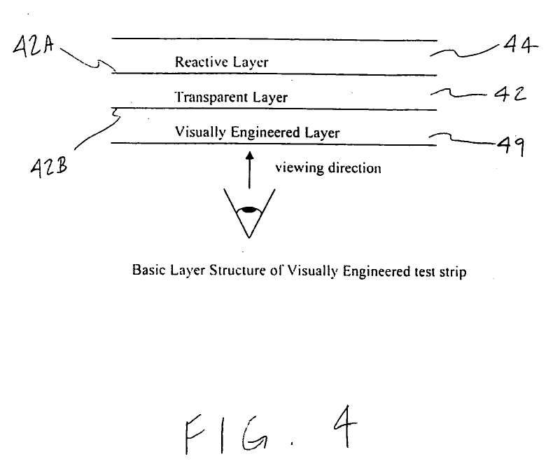

An example of such visual engineering is illustrated in FIG. 4, which is a side view of the analytical element 12 shown in FIG. 1A. The analytical element 12 includes a transparent layer, which can be, for example, a transparent film base 42 having a first side 42A and a second or viewing side 42B. The transparent film base 42 can be of polymer or other materials suitable for the purpose. A reactive layer 44 is coated onto or otherwise positioned facing the first side 42A of the transparent layer 42. The reactive layer 44 contains dye (or other color forming substance) and changes colorimetrically in response to concentration of a target analyte. This color change is viewable by a user through the transparent layer 44.

A visually engineered layer 49, which can be, for example, colored patterns and/or figures, is applied to the viewing side 42B of the transparent layer 42. The resulting display shows the sudden appearance of a symbolic readout as the analytical element 12 reacts to its exposure to the target analyte. That is, a substantially linearly-varying signal displayed on the display is perceived by a user as a step-like signal.

In other embodiments, the analytic element 12 can include additional layers. In one such embodiment (not shown), there are detection and/or amplification layers that are coated on top of a reflective titanium dioxide layer which is in turn coated over a mordant layer that has been coated on the transparent polymer film 42. In such embodiment, dye or color forming substance evolved in the detection and amplification layers migrates to the mordant layer where it is sequestered and color is viewed through the clear polymer film 42.

Visual engineering can also be performed on the first side 42A of the transparent polymer base 42 where the layers of the analytical element 12 have been coated. One such means is to emboss the transparent layer 42 so as to pattern the reactive layer 44. Another means is to engineer the reactive layer 44 so as to pattern the color evolution. Such engineering may be peculiar to the particular analytical element 12 and the target analyte. However, for simplicity, examples of visual engineering described below are performed on the second side 42B of the transparent polymer base 42.

The present disclosure also includes a method of making detectors, such as, for example, the analytic element 12 described with regard to FIG. 4. The method includes providing a transparent layer 42 having a first side 42A and a viewing side 42B. A reactive layer 44 is provided and faces the first side 42A of the transparent layer 42. The reactive layer 44 changes colorimetrically in response to concentration of the target analyte. A visually engineered layer 49 is applied to the second side 42B of the transparent layer 42 to form a display. A substantially linearly-varying signal displayed on the resulting display is perceived by a user as a substantially step-like signal.

Colorimetric analytical elements 12 such as test strips and badges come in various forms and in various levels of complexity. Some have many more layers than the example provided above and some have only one layer. The present invention is thus applicable to all levels of complexity of coated analytical elements 12.

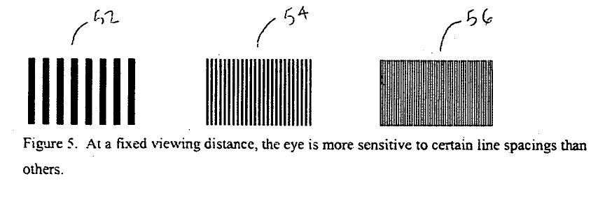

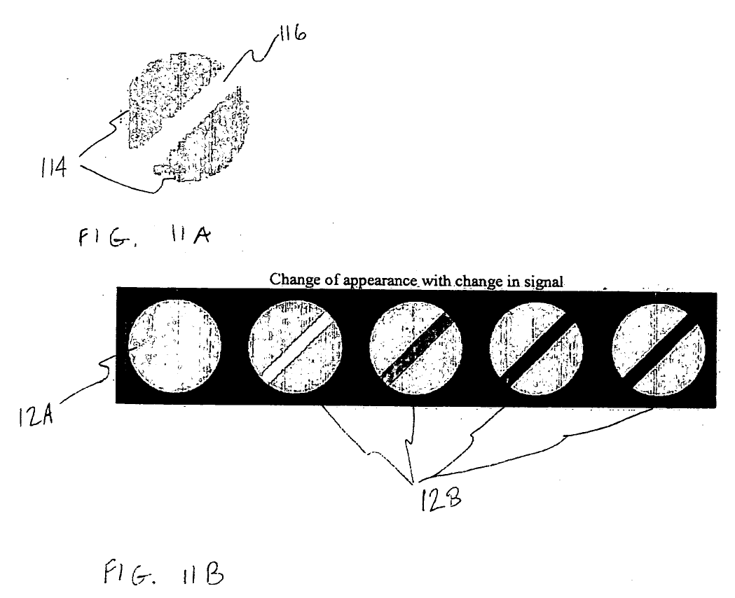

As described below with reference to FIGS. 5-16, the present invention combines vision, color and imaging techniques with coating technology to achieve the desired readout properties. For example, aspects of the psychophysics of human vision are combined with printing technologies such as half toning and dithering.

As noted above, human visual perception can be affected by three categories of phenomena: psychophysical, psychological, and physical. Each of these categories in turn gives rise to a class of tools. These tools are the components of visual engineering.

The first class of tools, psychophysical tools, include those whose impact derives from the physical structure of the human eye. Given the properties of the rods, cones, and neurons in the eye (including their size and position in the retina, and their varying spectral sensitivity and sensitivity to hue as a function of luminance) one can pattern the viewing surface 42B of the analytical element 12 such that distinct lines or features are perceived suddenly when the analytical element 12 develops a specific optical density.

FIG. 5 illustrates that, as a result of the structure of the rods and cones in the human retina, at a fixed distance the eye is more sensitive to certain line spacings than others, i.e. certain spatial frequencies. The central line group 54, when printed at sufficient resolution and contrast, catches the viewer's eye at standard reading distance, making a significantly greater visual impact than the other line groups 52, 56. The eye's sensitivity is also strongly dependent on light level. Patterns such as those shown in FIG. 5 compose the active image elements of the Visually Engineered Layer 49. Most often, the calorimetric response of the analytical element 12 will be incorporated into active image elements that will vary in appearance depending on extent of exposure to analyte.

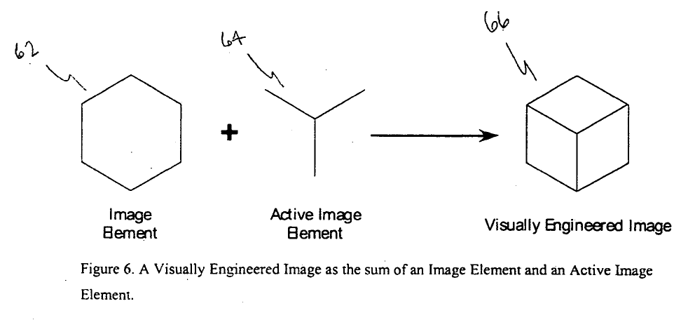

For the second class of tools, psychological tools, Applicant utilizes the perceptual power of the upper brain to assemble or alter an image from subcomponents added to the active image elements. For example, in FIG. 6, a visually engineered image 66 is assembled from subimages 62, 64 (some of which incorporate the colorimetric signal) that the human visual system will assemble into a symbolic readout. In FIG. 6, a patterned hexagonal overlay 62 is combined with a Y-shaped detector signal 64 so as to result in a figure that the brain perceives as a completely different object, a 3-dimensional cube 66.

The third class of tools, physical tools, are ones that selectively modify the amount of light reflected from the display. As noted above, these physical tools include patterns with varying opacity, halftone patterns, and color matching image segments.

According to the present invention, many aspects of human vision can be exploited by appropriate Visually Engineered Images. One example is Edge Effects. While the human eye can only perceive relative optical density changes of about 10% in different portions of the same viewing field, it can detect a 0.3% change in contrast at an edge. This heightened perception of edges results from the discrete size of ganglion cells and their inhibitory effect upon adjacent receptor units. In the simplest case, this allows the use of a mask that is exactly the same color as is the analytical element 12 prior to exposure. Any color change in the analytical element 12 above the 0.3% Edge Effect limit will provide a distinct signal to the viewer. This is useful in an analytical element 12 where the necessary signal is binary, that is, either the target analyte is present or it is not. The hue, brightness, and saturation of the mask must match that of the reactive optical element exactly, or the edge effect will be counterproductive and cause a faint perception of the image before test strip exposure.

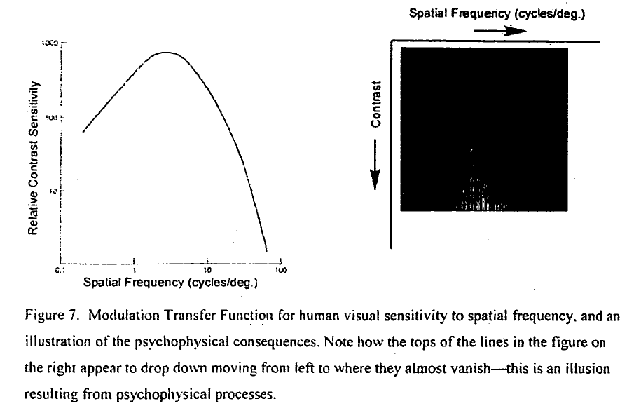

Referring to FIG. 7, Spatial Frequency Effects are another example of human visual perception that can be exploited according to the principles of the instant invention. FIG. 7 shows the sensitivity of the human eye to contrast as a function of the spatial frequency of parallel lines. Given the finite diameter of the neurons, the eye responds more or less strongly to images as a function of their focused spatial frequency and size on the retina. This characteristic of the eye is described by the modulation transfer function (MTF), which gives the sensitivity of the eye as a function of the spatial frequency of a line pattern in cycles/degree.

The left side of FIG. 7 illustrates the Modulation Transfer Function for human visual sensitivity to spatial frequency, and the right side of FIG. 7 illustrates the psychophysical consequences. Note how the tops of the lines in the graph on the right appear to drop down, moving from the left to where they almost vanish—this is an illusion resulting from psychophysical processes. Lines and patterns can be broken down into their Fourier components to understand the eye's sensitivity to a Visually Engineered Image. High contrast between light and dark lines of the components will be detected more easily than low contrast components within the sensitivity of the MTF function shown in FIG. 7. Another related tool results from the empirical observation that the human eye detects lines with greater sensitivity than a series of points or dots.

It is important that the time period for observation of the display by the user allows full cognition of the desired image. For field analytical scientists who can afford to stare at the image for many seconds, this is unlikely to be an issue. But for first responders who use chemical detectors in emergency situations, a quick glance may be all the time they have to make a critical decision as to how to act. Certain images can be misread with short reading periods.

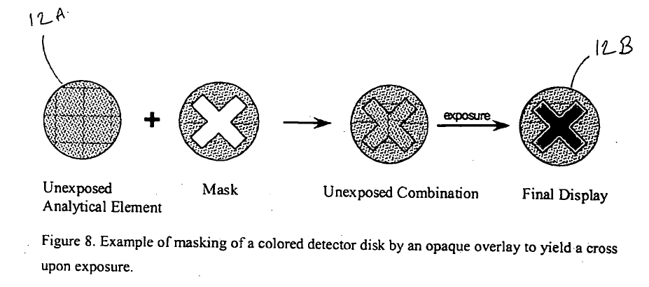

An important example of a useful image element is a mask. FIG. 8 illustrates one example of masking of a colored detector disk 12A, 12B by an opaque overlay to yield a cross upon exposure. A mask blocks all view of the detector signal except within a designated area. A solid color mask by itself is too easily seen because of the edge effect sensitivity of the eye, and the difficulty of matching the hue, luminance, and saturation of the masked image and the unexposed analytical element signal. Instead, the edges must be softened in order to eliminate edge effects prior to exposure of the analytical element 12A, 12B. “Softening” of images so as to decrease the edge effects can be accomplished in a number of ways. The edge of the mask can be softened through the isolation of just the fundamental spatial Fourier component. This can be done by gradually reducing the opacity of the mask near the edge. Another method to obscure the high frequency components of an edge is through addition of high frequency, low amplitude variations of optical density or color. In this manner, the eye is strongly hindered from perception of the edge. Yet another method uses irregular spots and ovals of varying intensity at the mask's edge to dissipate the edge effect. This is equivalent to the addition of many high frequency components near the edge to obscure its perception.

Figural Grouping is a very useful visual psychology phenomenon. The brain will group disparate Active Visual Elements into figures, symbols or images if the Active Visual Elements are situated on the test strip 12 or other analytical element surface in the proper spatial relation to each other. This figural grouping can follow several Gestalt principles of perceptual organization: proximity, similarity, closure, and continuation. If, for example, many small 2 mm diameter Active Visual Elements of a pure color change are appropriately arranged in proximity, the brain will group them into a figure. Such small circles of color will also be seen as a distinct group because of similarity, even when separated by a sea of colored triangles or squares incorporated into the Visually Engineered Image. For example, individual circular Active Visual Elements strung out in a linear arrangement will be perceived by the brain as connected.

Many other figural grouping concepts exist and may be employed according to the present invention. Combinations of groupings of Active Visual Elements using spatial frequency functions can be especially powerful. Additional design considerations include the hue, saturation, and luminance of the analytical element 12 being modified. In the design of the perception-modifying images described herein, the evolution of the hue of the analytical element 12 as it is exposed is important. Fully 8% of the male population suffers from color deficiencies of some kind. The bulk of this color deficient population are red-green color blind, so a yellow/blue color scheme will serve them well.

Also requiring consideration in the design of a Visually Engineered Image are the lighting conditions for viewing the test strip 12 or other colorimetric analytical element. For example, under low light (i.e. scotopic) conditions, the rods dominate human vision and the maximum wavelength of the eye's sensitivity is shifted from 550 nm down to 500 nm. The spatial frequency sensitivity of the eye is also shifted.

The visually engineered images in the analytical elements 12 can be created using ink jet printers, thermal web embossing presses, screen printers, or any other standard color printing methods appropriate for the underlying material. Newer technologies like thermal transfer processes, such as laser ablation, can also be used to create the colored patterns on the viewing surface 42B of the analytical element 12 that modify the appearance of the exposed analytical element 12 from a continuous color change to the relatively sudden appearance of a recognizable image or symbol.

The following examples, illustrate how the Visually Engineered Layer 49 can be implemented to achieve the desired effects described above. This set of examples illustrates the process of engineering the human response to a smoothly varying display into a more abrupt response by adding combinations of image elements in a Visually Engineered Layer 49 so as to produce a Visually Engineered Image. This Visually Engineered Image in turn combines with an active image element to result in an altered perceptual signal.

### EXAMPLE 1

Reference Ring

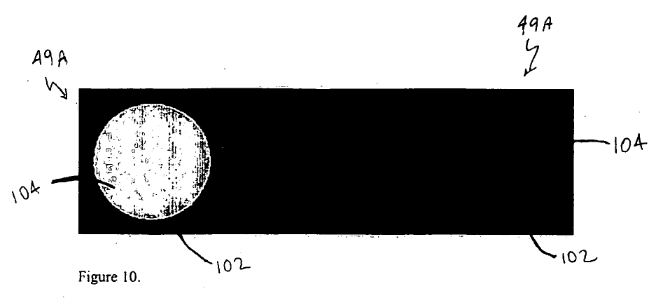

As one example of a psychological use of selected image elements, FIG. 10 illustrates the use of a reference ring 102. By placing the opaque ring 102 around the outer edge of a circular display 104, a reference can be established for identifying the desired signal. In the case of a signal that changes from off white to dark blue, the reference ring 102 can be selected that matches 75% maximum blue. The complete reaction is darker and bluer than the desired transition point. Less complete than 75% maximum blue will appear lighter and less blue. This is a tool to identify the desired level of signal.

### EXAMPLE 2

Opaque Layer

As an example of a psychological use of selected image elements, FIG. 1A illustrates a printed opaque layer or mask 114 that creates a desired shape out of the reactive layer 116. As seen in FIG. 1I B, by having the opaque layer 114 match the initial color of the reactive layer 116, the diagonal line is not visible in the unexposed analytical element 12A, but becomes visible in the exposed analytical element 12B, forming the international “NoGo” symbol of a diagonal crossbar in a ring.

### EXAMPLE 3

Semi-Transparent Layer

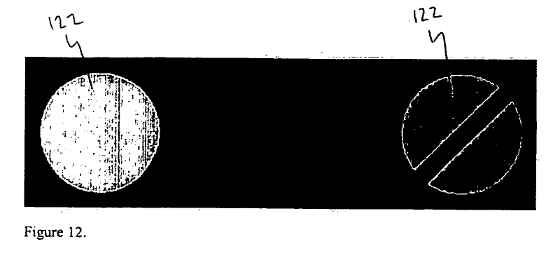

An example of a physical use of selected image elements, shown in FIG. 12, is a semi-transparent layer. By making the mask 122 semi-transparent, it changes color at a different rate than the unmasked reactive layer. The semi-transparent layer makes the edge between the reactive layer and the mask 122 less perceptible, thereby delaying perception of the signal.

### EXAMPLE 4

Semi-Transparent Layer

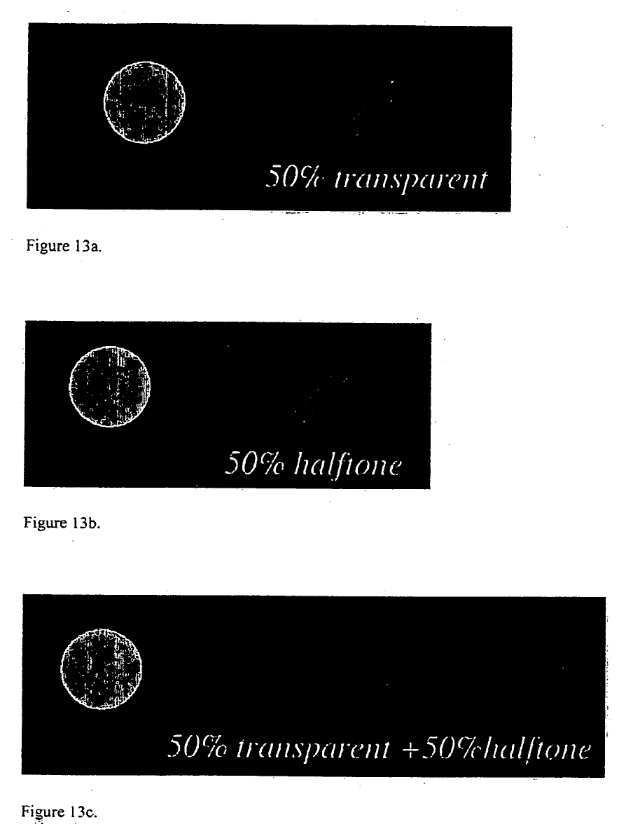

FIGS. 13A, 13B and 13C illustrate another example of physical tools used to modify the selected image elements. As in FIG. 12, the mask layer is semi-transparent and therefore changes color at a different rate than the reactive layer. Shown are three methods of making the mask semi-transparent. A first method, as shown in FIG. 13A, is to uniformly apply a semi-transparent ink. A second method, as shown in FIG. 13B, is to use a halftone pattern composed of opaque ink alternating with transparent areas. A third method, as shown in FIG. 13C, is to combine semi-transparent ink and halftone patterns.

### EXAMPLE 5

Semi-Transparent Color Layer

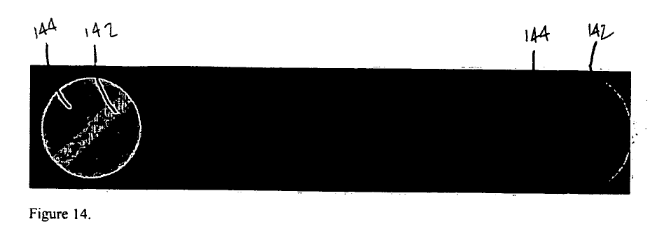

Another example of a physical use of selected image elements is a semi-transparent layer incorporating a complementary color, as shown in FIG. 14. In this particular example, the reactive layer 142 changes from off-white to dark blue as the signal develops. The background 144 is initially a semi-transparent orange that will be perceived as changing to gray as the reactive layer changes to blue.

### EXAMPLE 6

Halftoning

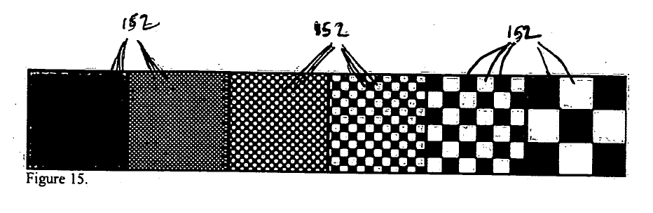

In FIG. 15, yet another example of a psychophysical use of selected image elements is shown with different sizes of halftone. That is, FIG. 15 shows the effect of spatial frequency on a halftone pattern. Note the change in appearance of the white and black checkerboard elements 152 with change in size and associated change in spatial-frequency distributions on the retina of the observer. The spatial-frequency distribution controls the visibility of image segments.

### EXAMPLE 7

Distracting Elements

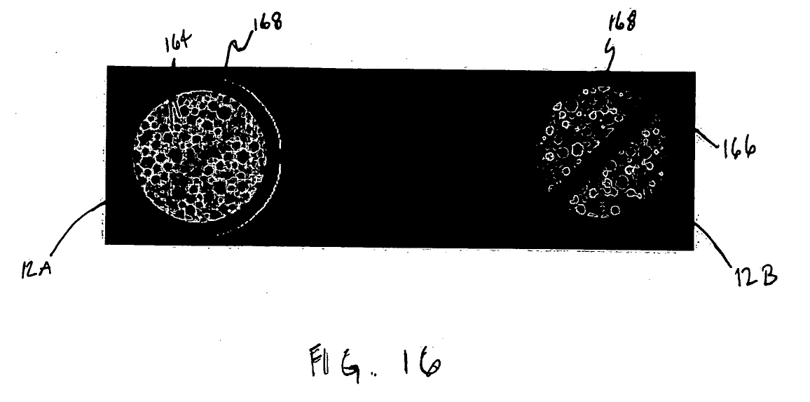

FIG. 16 illustrates a psychological use of selected image elements, namely, the effect of adding distracting elements to a semi-transparent layer. The edges of the diagonal line 166 are obscured by an overall pattern of small circles 164 of varying size and complementary shades. Where the circles 164 overlap the diagonal line 166, they have been made semi-transparent, so the color change of the reactive layer can be seen through them, whereas in the rest of the pattern they are opaque. The diagonal line 166 is significantly less visible both in the unexposed display 12A and at low levels of reactive layer development. When the reactive layer darkens sufficiently, the international No-Go signal becomes perceptible (exposed display 12B). Tests with human observers have indicated that the diagonal line 166 is imperceptible below about 20% of the optical density of the outer ring 168.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. An analytical element for indicating concentration of a target analyte, comprising:
a transparent layer having a first side and a viewing side;
a reactive layer facing the first side of the transparent layer, said reactive layer changing colorimetrically in response to concentration of the target analyte; and
a visually engineered layer applied to the second side of the transparent layer so as to form a display,
a substantially linearly-varying signal displayed on the display is perceived by a user as a substantially step-like signal.

2. The analytical element of claim 1, wherein the signal is a change in at least one of color, hue, luminance, and saturation.

3. The analytical element of claim 1, wherein a symbolic readout of the display is perceived as appearing instantaneously when a threshold level of target analyte is reached.

4. The analytical element of claim 1, wherein the visually engineered layer is a colored pattern.

5. The analytical element of claim 1, wherein the visually engineered layer varies in appearance depending on the extent of exposure to the analyte.

6. The analytical element of claim 1, wherein the analytic element is used for detecting at least one of chemicals, biologicals and physical changes in an environment.

7. The analytical element of claim 1, wherein a detector characteristic curve associated with said substantially linear signal is converted into a non-linear perceptual signal.

8. The analytic element of claim 1 wherein said visually engineered layer is a mask.

9. The analytic element of claim 8 wherein said mask is semi-transparent to delay perception of the signal.

10. The analytic element of claim 9 wherein said mask incorporates distracting elements which obscure perception by a user of the reactive layer.

11. The analytic element of claim 10 wherein said mask incorporates a reference portion.

12. The analytic element of claim 8 wherein a portion of the mask is a complementary color to that of the reactive layer.

13. The analytic element of claim 8 wherein a portion of the mask includes a halftone pattern.

14. The analytic element of claim 8 wherein said mask includes one or more of distracting elements, a reference portion, complementary color portions, or halftone pattern portions.

15. The analytic element of claim 8 wherein said mask includes at least two of distracting elements, reference portions, complementary color portions and halftone pattern portions.

16. The analytic element of claim 1, wherein the visually engineered layer faces the first side of the transparent layer.

17. The analytic element of claim 1 further comprising at least one of a mordanting layer and a reflecting layer positioned between the reactive layer and the transparent layer.

18. A method of making an analytical element for indicating concentration of a target analyte, the method comprising the steps of:
providing a transparent layer having a first side and a viewing side;
providing a reactive layer facing the first side of the transparent layer, said reactive layer changing colorimetrically in response to concentration of the target analyte; and
applying a visually engineered layer to the second side of the transparent layer to form a display,
such that a substantially linearly-varying signal displayed on the display is perceived by a user as a substantially step-like signal.

19. The method of claim 18, wherein application of the visually engineered layer converts a detector characteristic curve that is a property of a substantially linearly varying signal into a non-linear perceptual signal.

20. The method of claim 18, wherein the visually engineered layer is applied using at least one of psychological, psychophysical, or physical tools.
